(19) United States
(12) Patent Application Publication
(10) Pub. No.: US 2006/0025104 A1
(43) Pub. Date: Feb. 2, 2006

(54) Dynamic trim to mitigate transients

(76) Inventors: Byron M. Reed, Murphy, TX (US); Kevin M. Ovens, Frisco, TX (US)

Correspondence Address: TEXAS INSTRUMENTS INCORPORATED, P O BOX 655474, M/S 3999, DALLAS, TX, 75265, US

(21) Appl. No.: 10/901,664

(22) Filed: Jul. 29, 2004

(51) Int. Cl. H04B 1/16; H04B 1/38; H04M 1/00

(52) U.S. Cl. 455/343.1; 455/572

(57) ABSTRACT

Systems and methods are disclosed to mitigate a transient condition in electrical energy that is supplied to a load. A power supply system includes a converter that supplies regulated electrical energy to an associated load. A feedback network provides a reference signal based on the regulated electrical energy being supplied to the load, the regulator controlling the regulated electrical energy based on the reference signal. The feedback network is modified to adjust the reference signal so as to mitigate a transient condition in the regulated electrical energy.

### TECHNICAL FIELD

The present invention relates to integrated circuits, and more specifically relates to employing dynamic trim to mitigate transients in an electrical circuit.

### BACKGROUND

Portable electronic devices continue to become increasingly complex. For example, mobile telephones are no longer limited to providing telephone functionality, but are also implementing multimedia and other functions. The increased complexity of portable devices imposes a tremendous burden on power consumption and battery lifetime. Despite the additional features being implemented in various devices, the manufacturers of these devices and their customers typically require substantially the same or even improved battery lifetime. Various types of power control systems have been developed that dynamically control the output voltage of a power supply.

One approach employs a power control system to operate a DC-DC buck converter for supplying the voltage to the core circuitry of the electronic device. FIG. 1 depicts an example of a power supply (e.g., including a DC-DC buck converter) 10 that can be used to provide regulated power for various applications. A control system 12 controls one or more switches of a switch network 14 to supply current to an associated load 16 through an inductor 18. A capacitor 20 is coupled across the load 16. The control system 12 calculates an error voltage and adjusts the output voltage of the converter 10 accordingly. In order to achieve performance with minimum energy consumption, the control system operates to minimize the voltage. Since the output voltage is set to a minimum, the amount of transient (e.g., undershoot or overshoot) in the converter should also be minimized. When the load changes from low current to high current, for example, the converter energizes the inductor 18 before the current can be supplied to the load 16. The delay in supplying the current to the load 16 causes the output voltage to droop or undershoot.

In view of the increased requirements of portable electronic devices, it is desirable to provide power supplies and converters that can mitigate transients.

### SUMMARY

The present invention relates to systems and methods operative to mitigate a transient condition in electrical energy that is supplied to a load. By mitigating transient conditions in the electrical energy, battery lifetime can be increased.

One aspect of the present invention relates to a power supply system includes a converter that supplies regulated electrical energy (e.g., voltage or current) to an associated load. A feedback network provides a reference signal based on the regulated electrical energy being supplied to the load, the regulator controlling the regulated electrical energy based on the reference signal. The feedback network is modified to adjust the reference signal so as to mitigate a transient condition in the regulated electrical energy.

Another aspect of the present invention relates to a power supply system that includes a converter comprising a high-side switch, a low-side switch and an inductor coupled to a node between the high-side switch and the low-side switch and to an output node. A feedback network provides a reference signal based on a regulated electrical energy that is supplied to the load. A control system controls the high-side switch and the low-side switch to provide regulated electrical energy at the output node based on the reference signal relative to a predetermined oscillating input signal. The control system dynamically trims the feedback network to adjust the reference signal based on the reference signal being outside an expected range of the oscillating input signal, such as corresponds to detecting a transient condition at the output node.

Still another aspect of the present invention relates to a method for mitigating transient electrical characteristics in electrical energy supplied to an associated load. The method includes providing regulated electrical energy to the load based on a feedback signal indicative of the regulated electrical energy that is supplied to the load. The feedback signal is trimmed to mitigate a difference between the feedback signal and a range of a predetermined oscillating input signal in response to detecting a potential transient condition in the regulated electrical energy that is being provided to the load.

### BRIEF DESCRIPTION OF THE DRAWINGS

FIG. 1 depicts an example of a conventional power supply with a DC-DC buck converter.

FIG. 2 depicts a power supply system that can be implemented in accordance with an aspect of the present invention.

FIG. 3 depicts an example of another power supply system that can be implemented in accordance with an aspect of the present invention.

FIG. 4 depicts an example of a dynamic trim system that can be implemented in accordance with an aspect of the present invention.

FIG. 5 is a graph depicting voltages associated with operation of a conventional converter.

FIG. 6 is a graph depicting voltages associated with operation of a converter implemented in accordance with an aspect of the present invention.

FIG. 7 depicts an example of a portable electronic device implementing a power supply system in accordance with aspect of the present invention.

FIG. 8 depicts an example of a method for supplying regulated power in accordance with aspect of the present invention.

### DETAILED DESCRIPTION

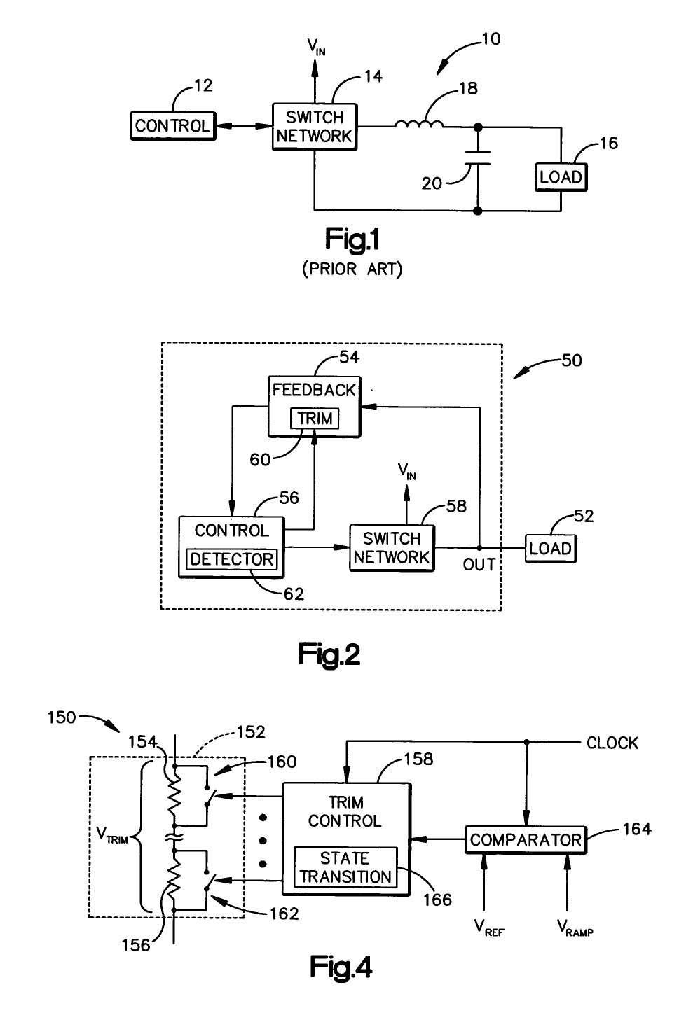

FIG. 2 depicts an example of a power supply system 50 that can be implemented according to an aspect of the present invention. The power supply system is operative to provide regulated electrical power, indicated at OUT, to a load 52. The power supply system 50 can be configured to supply a substantially fixed output (e.g., voltage or current) to the load 52 or a variable output to the load. The power supply system 50 can also vary OUT according to requirements of the load 52.

The system 50 includes a feedback network 54 coupled to receive an indication of the OUT signal. The feedback network 54 in turn provides a feedback signal to a control system 56. The control system 56 employs the feedback signal to provide a corresponding control signal to an associated switch network 58. The control system 56 and the switch network 58 define a regulator, in which the switch network 58 is coupled to provide the regulated OUT signal based on the control signal.

For example, the switch network 58 can include a combination of one or more switch devices (e.g., transistors) that provide the OUT signal to the load 52 as a regulated voltage as a fractional part of the available voltage provided by a battery, indicated at V_{IN}. The power supply system 50 further can be operative to supply the OUT signal to the load 52 at a plurality of programmable levels. Thus, the system 50 can provide the OUT signal at a selected voltage level by controlling current from the switch network 58 according to an operating mode of the system (e.g., a sleep mode or normal mode) or based on step changes in the load resistance.

The feedback network 54 includes a trim component 60 that is operative to adjust the feedback signal provided to the control system 56 according to an aspect of the present invention. For example, the trim component may be a variable impedance element, such as a variable resistance network, a switched capacitor network and the like. In the example of FIG. 1, the control system 56 includes a detector 62 operative to detect transient condition in the OUT signal based on the feedback signal, which can be proportional to the OUT signal. The feedback signal can also be programmed to vary according to an operating mode of the power supply system to set a desired level of the OUT signal. The detector 62 is operative to, in response to detecting a transient condition in the OUT signal, set the trim component 60 to adjust the feedback signal so as to mitigate transients in the OUT signal.

As an example, the control system 56 can compare the feedback signal relative to an oscillating ramp signal. The control system 56 employs the comparison to control the switch network 58. In response to detecting that the feedback signal is outside an expected, normal operating range (e.g., corresponding to a step change in the load resistance or other transient condition in the OUT signal), the detector 62 can dynamically trim the trim component 60 of the feedback network 54. The dynamic trimming of the trim component 60 can apply a DC offset that causes the feedback signal to return more quickly to a level that is within the normal operating range of the ramp signal. The DC offset thus operates to mitigate a difference between the feedback signal and a range of the ramp signal. As a result of bringing the feedback signal to within the range of the ramp signal, the control system 56 can, in turn, drive the switch network 58 to stabilize the OUT signal, and thereby mitigate undershoot or overshoot in an output voltage at OUT. Those skilled in the art will understand and appreciated that the power supply 50 thus is capable of stabilizing and returning the OUT signal to a steady state condition when transient conditions occur in the OUT, such as in response to load changes, more quickly than many existing power supply system and regulators. By reducing the time that is required to stabilize the OUT signal, the power supply system affords an increase in the battery life for devices incorporating the power supply system 50.

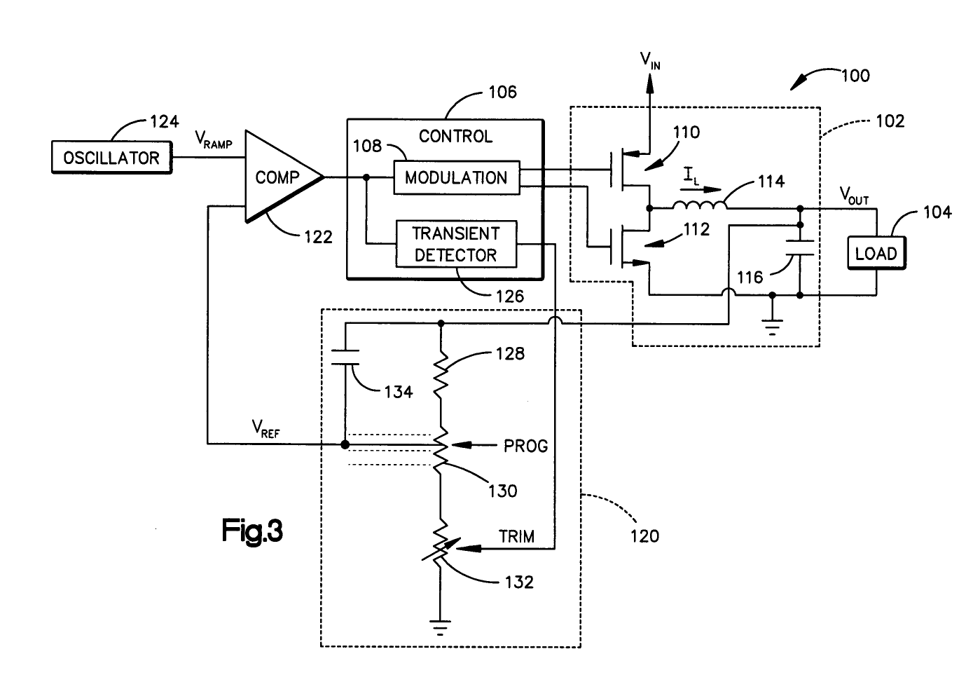

FIG. 3 depicts an example of another power supply system 100 that can be implemented in accordance with an aspect of the present invention. The power supply system 100 includes a converter 102 (e.g., a DC-DC buck converter) that is configured to provide regulated voltage V_{OUT} to an associated load 104. A control system 106 is coupled to control the converter 102 to provide V_{OUT} at a desired level, which can be substantially fixed or can vary according to, for example, requirements of the load.

By way of example, the control system 106 includes a modulation block 108 that is operative to drive a pair of switch devices 110 and 112 of the converter 102. In the example of FIG. 3, the switch devices 110 and 112 are respectively illustrated as a high-side P-type metal oxide semi-conductor field effect transistor (PMOSFET) and a low-side N-type MOSFET. The modulation block 108 thus drives the respective high side and low side switch devices 110 and 112 to provide a current I_{L} through an inductor 114, which results in providing the regulated V_{OUT} to the load 104. The inductor 114 is coupled to a node interconnected between the switch devices 110 and 112 and to the output of the converter 102. A capacitor 116 is coupled in parallel with the load 104 between the output of the converter and electrical ground to help stabilize V_{OUT} at the load 104 based on the current I_{L} that is supplied to the load.

A feedback network 120 is coupled between V_{OUT} and an input of a comparator 122 to provide a reference voltage V_{REF} to the comparator input. The feedback network 120 provides V_{REF} as a function of V_{OUT}. The comparator 122 compares V_{REF} relative to an oscillating ramp voltage V_{RAMP} that is provided by an oscillator 124. The comparator 122 provides a comparator output signal to the control system 106 based on the relative levels of the V_{REF} and V_{RAMP}.

The control system 106 further includes a transient detector 126 that is operative to detect a transient condition in V_{OUT} (e.g., corresponding to overshoot or undershoot) based on the comparator output signal. A transient condition may occur, for example, in response to load changes (step voltage change) or other transient conditions that might occur at V_{OUT}. The transient detector 126 provides a control signal (TRIM) to the feedback network 120 for adjusting V_{REF} in a direction that mitigates the detected transient in V_{OUT}. For instance, the TRIM control signal can cause the feedback network 120 to adjust V_{REF} to a level that is within the normal operating range of V_{RAMP}. By forcing V_{REF} to within the normal operating range of V_{RAMP} more quickly, the modulation block 108 can control the switch devices 110 and 112 to implement earlier switching (e.g., pulse-width modulation). The earlier switching of the devices 110 and 112 results in ramping the current I_{L} through the inductor 114 (e.g., up or down) to facilitate stabilization of V_{OUT}.

Turning to the contents of the feedback network 120, V_{REF} is generated by tapping a voltage from a node of a voltage divider network. The voltage divider network is formed of resistors 128, 130 and 132 coupled in series between V_{OUT} and electrical ground. A capacitor 134 is coupled in parallel with the series combination of resistors 128 and 130 (between V_{OUT} and V_{REF}) to provide DC stability for the feedback network 120. According to an aspect of the present invention, the resistor 132 provides a variable resistance based on the TRIM control signal. The transient detector provides the TRIM control signal to increase or decrease V_{REF} accordingly. That is, if the transient detector 126 provides the TRIM control signal to the variable resistor 132 to increase its resistance, V_{REF} will increase accordingly. Alternatively, the transient detector 126 can provide the TRIM control signal to decrease the resistance of the resistor 132, which results in a corresponding decrease in V_{REF}.

In order to enable the power supply system 100 to provide a programmable regulated output voltage V_{OUT}, the resistor 130 can also be programmable. To establish a desired output voltage, for example, a user can set the resistor 130 to a desired resistance based on a program (PROG) signal. The resistance values of the network 128, 130 and 132 are selected so that V_{REF} should remain within the range of V_{RAMP} during normal operation to establish a desired V_{OUT}. Those skilled in the art will understand and appreciate other ways in which V_{OUT} can be made programmable, such as by varying the amplitude of V_{RAMP}.

As an example, assuming that the load resistance changes such that V_{OUT} exhibits a transient increase in voltage. V_{REF} from the feedback network 120 results in a corresponding increase in voltage that is provided to the comparator. Assuming that the transient increase in V_{OUT} renders V_{REF} outside the normal operating range of the comparator (e.g., V_{REF} is substantially greater than V_{RAMP}), the output of the comparator 122 will remain in a given state (HIGH or LOW voltage) over a plurality of consecutive clock cycles so long as V_{REF} is outside the range of V_{RAMP}. In response to the comparator output signal no longer transitioning between states, as usually occurs during normal operation, the modulation block 108 controls the high side switch device 110 (e.g., in an OFF condition) to decrease or stop supplying the current I_{L} to the load 104 in an effort to reduce V_{OUT} and stabilize it to its desired regulated level. The transient detector 126, in response to detecting the absence of a state change in the comparator output signal over a plurality of clock signals, trims the variable resistor 132 so that V_{REF} decreases and thereby more quickly returns to a level within the normal operating range of V_{RAMP}. By causing V_{REF} to a level that is within the normal operating range of V_{RAMP}, the modulation control block 108 will re-activate the high side switch device 110 more quickly and result in earlier energizing of the inductor 114. By energizing the inductor 114 more quickly, undershoot in V_{OUT} can be mitigated. Those skilled in the art will understand and appreciate that a similar advantage in operation can be implemented to mitigate overshoot in V_{OUT}.

By way of comparison, in the absence of implementing the dynamic trim in the power supply system 100, there would be an additional delay associated with increasing the current I_{L} through the inductor 114. This delay would further result in a corresponding undershoot in V_{OUT} since the switch device 110 would not be reactivated until the V_{REF} signal has settled to within the range of the V_{RAMP} signal provided to the comparator 122. In contrast, the dynamic trimming implemented by the resistor 132 based on the TRIM control signal enables V_{REF} to settle to within the range of V_{RAMP} more quickly, which affords an early turn of the high-side switch device and reduced transients in V_{OUT}.

FIG. 4 depicts an example of a trimming system 150 that can be utilized to mitigate transients in a regulated output voltage, such as can be implemented in the power supply systems 50 and 100 of FIGS. 2 and 3. The system 150 includes a variable trim resistor 152 that includes a plurality of resistors 154 and 156 coupled in series. While two trim resistors 154 and 156 are illustrated in FIG. 4, those skilled in the art will understand and appreciate that any number of resistors can be utilized. The series combinations of resistors 154 and 156 provides a DC offset voltage potential across the series combination of resistors, indicated at V_{TRIM}, which depends on which of the resistors are connected into the variable resistor 152.

A trim control 158 can provide a multi-bit output system for controlling each of the respective resistors 154 and 156. For instance, switch devices (e.g., transistors) 160 and 162 can be coupled in parallel with the respective resistors 154 and 156. Thus, the trim control 158 can provide a multi-bit control signal to short out one or more resistor by activating a given one or both of the switch devices 160 and 162. Each of the resistors 154 and 156 may have different resistance values to provide additional flexibility for implementing different amounts of V_{TRIM}. The different resistor values enable the system 150 to provide different trim depending on, for example, the desired output voltage of the programmable converter in which the system 150 is being implemented. For instance, for a programmed output voltage of a converter that is above a predetermined value, a smaller one of the resistors (e.g., resistor 154) may be shorted and for programmed output voltages that are less than this predetermined value, a larger resistance (e.g., the resistor 156) can be shorted by the trim control 158.

A comparator 164 compares a reference voltage V_{REF} relative to a ramp signal V_{RAMP}. V_{REF} varies based on V_{TRIM}, such as by V_{TRIM} providing a DC offset to the level of V_{REF}. The amount of trimming implemented by the control 158 can be selected to ensure that the V_{TRIM} does not exceed the peak-to-peak voltage of a ramp signal V_{RAMP} during normal operation. The comparator 164 provides the comparator output signal to the trim control 158 based upon a comparison of V_{REF} relative to V_{RAMP}.

The comparator 164 can provide the comparator output signal in three general modes. In a first mode, corresponding to a condition to where V_{REF} is too high, the comparator output signal can provide a steady state (e.g., HIGH) output signal. This steady state comparator output signal indicates a transient condition in which V_{REF} exceeds the high peak voltage of V_{RAMP}. In response to detecting steady state (e.g., HIGH) output signal for a plurality of clock signals, a state transition detection block 166 of the trim control 158 provides the trim control signal to implement suitable trimming of one or more of the resistors 154 and (e.g., providing a negative DC offset) 156. This trimming results in a reduced V_{REF} being provided back to the comparator since V_{REF} is functionally related to the V_{TRIM}.

In a second, normal operating mode, V_{REF} is within a normal range of V_{RAMP}, such that the comparator output signal changes states between high and low voltages, such as every N clock cycles, where N is a positive integer (e.g., N≧1, typically N=1) denoting the rate of transitions in the comparator output signal. Thus, when the state transition detection block 166 detects that state changes in the comparator output signal occur within expected operating parameters, the trim control 158 does not activate the switch devices 160 and 162 to implement trimming of the variable resistor 152. As a result, stabilization of a corresponding output voltage is implemented by controlling modulation of an associated switch device, which can have variable pulse widths based on the comparator output signal, such as described herein.

In a third operating mode of the comparator 164, V_{REF} is too low relative to Vᵣₐₘₚ. In this third operating mode, the comparator 164 provides the comparator output signal as a steady state (e.g., LOW) signal for a plurality of clock cycles. This steady state comparator output signal indicates a transient condition in which V_{REF} is below the low peak voltage of V_{RAMP}. In response to detecting such a steady state (e.g., LOW) output voltage for a plurality of clock cycles, a state transition detection block 166 of the trim control 158 provides the trim (e.g., a positive DC offset) can implement additional trimming of one or more of the resistors 154 and 156 so that VREF more quickly settles to within the peak-to-peak range of V_{RAMP}

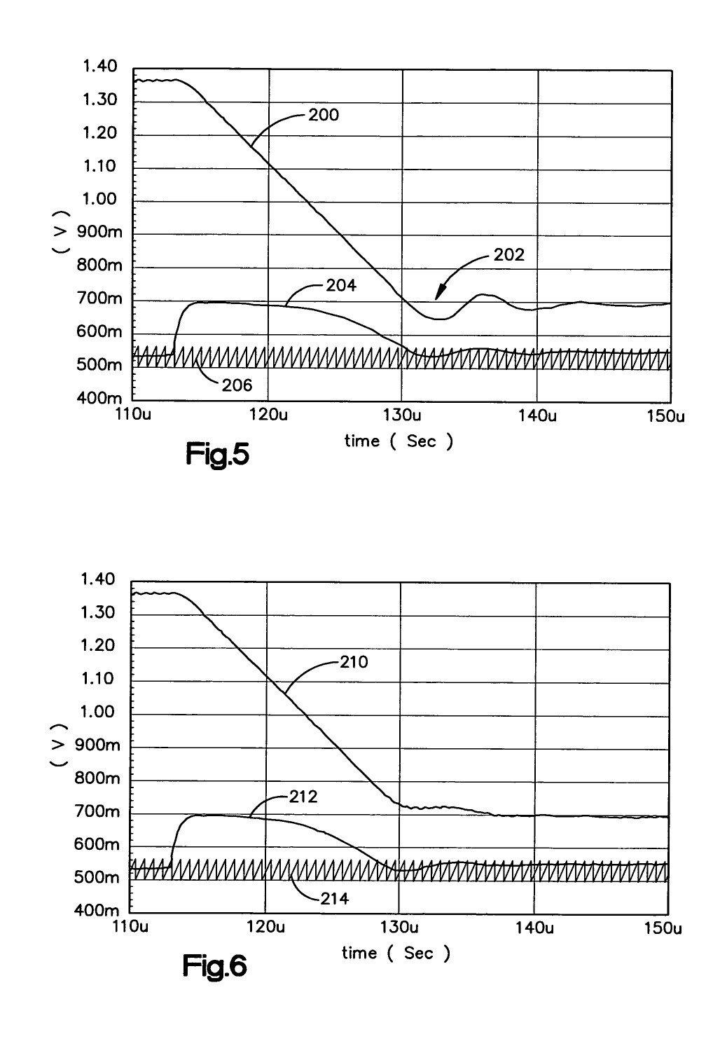

By way of further comparison, FIGS. 5 and 6 depicts graphs illustrating electrical characteristics for a converter experiencing a down step in a regulated output voltage. For each of the examples of FIGS. 5 and 6, reference can be made back to FIG. 3 in which the following simulation conditions exist: V_{IN}=3.6 volts, the inductor 114 has inductance of 6.8 μH, the capacitor 116 has capacitance of 10 μF, the capacitor 134 has capacitance of 16.5 pF and a ramp signal is provided at a frequency of 1.5 MHz.

FIG. 5 depicts a regulated output voltage 200 for a power supply system in the absence of implementing dynamic trimming. The output voltage 200 steps down from 1.36 to about 0.7 volts but exhibits significant undershoot, indicated at 202. A reference voltage, indicated at 204, is provided by a feedback network (e.g., feedback network 120 of FIG. 3) to control the down step in the output voltage 200. The reference voltage 204 remains outside the operating range of the ramp voltage 206 until approximately 130 microseconds at which time the output voltage 200 exhibits an undershoot 202. The undershoot 202 that accompanies the down step in the output voltage results in an increased time for stabilizing V_{OUT} to the new voltage at 0.7 volts. Additionally the undershoot 202 will decrease in the battery lifetime.

FIG. 6 depicts an output voltage 210 for a power supply system implementing dynamic feedback trimming according to an aspect of the present invention. The output voltage 210 steps down from 1.36 volts to 0.7 volts, and exhibits little or no undershoot. For example, a reference voltage 212 increases at about the same time as with respect to the example of FIG. 5 to initiate the down step in voltage from 1.36 to 0.7 volts. However, according to an aspect of the present invention, the reference voltage 212 is forced into within range of the ramp voltage 214 more quickly by implementing dynamic trim of a feedback network, such as described herein. Since V_{REF} is forced to return to a level within the range of the ramp voltage 214 more quickly, undershoot in the output voltage does not occur. As a result, battery life can be increased accordingly. Those skilled in the art will understand and appreciate that such dynamic trim could be utilized for mitigating any transient conditions in the output voltage 210.

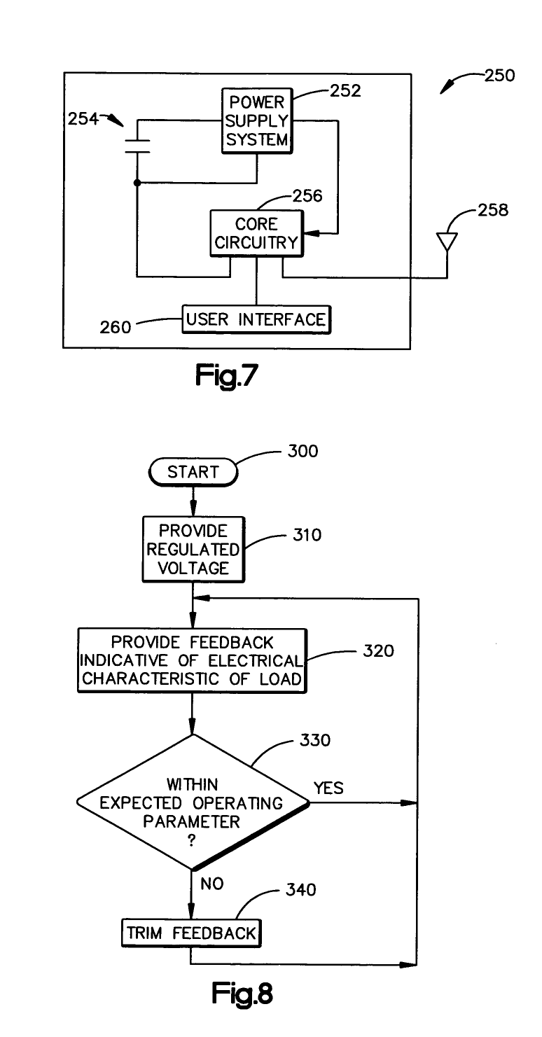

FIG. 7 depicts an example of a portable electronic apparatus 250, such as a mobile communications device (e.g., a cellular telephone, personal digital assistant, portable computer and the like) implementing a power supply system 252 according to an aspect of the present invention. Those skilled in the art will understand and appreciate various implementations for the power supply system 252 based on the teachings contained herein, including but not limited to those shown and described with respect to FIGS. 2, 3, 4 and 8.

The power supply system 252 is coupled to a battery 254 for converting an input voltage from the battery to a desired regulated voltage level. The power supply system 252 provides regulated power (e.g., regulated voltage or current) to associated core circuitry 256. The regulated power can vary based on the input impedance of the core circuitry of the apparatus 250. The core circuitry 256 can include analog or digital components configured and/or programmed to implement the functionality of the particular type of apparatus 250 being implemented. In the example of FIG. 7, the core circuitry 256 is coupled to an antenna 258, such as for transmitting or receiving wireless communication signals, although the power supply system can be utilized in any electronic device. A user interface 260 (e.g., including a keypad, touch-screen, microphone, etc.) can also be coupled to the core circuitry 256 for providing input instructions from a user to the core circuitry.

By way of example, the apparatus 250 can operate in a plurality of operating modes, including at least a low power sleep mode and an active (or normal) mode. The power supply system 252 is configured to mitigate transients that might occur during a change in the resistance or other step change in the output voltage provided to the core circuitry 256. As described herein, the power supply system 252 includes a feedback network that provides an indication of the regulated power (e.g., voltage or current) being supplied to the core circuitry 256. The feedback network includes a trim system operative to modify the feedback network to adjust a reference signal that is utilized (e.g., by a controller) to adjust the regulated power. The feedback network is modified to bring the reference signal within a normal operating range of a comparator so that the output voltage provided to the core circuitry 256 can be stabilized more quickly. As a result, transients in the electrical characteristics in the electrical power supplied to the core circuitry 256 can be mitigated.

FIG. 8 depicts an example of a method that can be utilized to mitigate transients in regulated electrical energy of a converter. The converter is configured, for example, to provide a regulated output voltage by pulse width modulation of one or more switch devices (or current) connected between a battery and an associated load. While, for purposes of simplicity of explanation, the methodology 300 is shown and described as executing serially, it is to be understood and appreciated that the present invention is not limited by the order shown, as some aspects may, in accordance with the present invention, occur in different orders or concurrently from that shown and described herein. Moreover, not all features shown or described may be needed to implement a methodology in accordance with the present invention. Additionally, such methodology can be implemented in hardware (e.g., analog circuitry, digital circuitry or a combination thereof), software (e.g., running on a DSP or ASIC) or a combination of hardware and software.

The method of FIG. 8 begins at 300 such as in conjunction with power up of the circuitry (e.g., an electronic device or appliance) that includes the electrical power supply system implementing the method. At power up, for example, a converter can be controlled initially to provide voltage at a high voltage level (e.g., corresponding to battery voltage of 1.5 V) and, after stabilizing to such high level, transition downward to a desired regulated voltage (e.g., 1.2 V). This downward adjustment from the high voltage to the regulated voltage further can implement the method of FIG. 8 to mitigate undershoot associated with the transition to the desired regulated voltage of 1.2 volts. The method further can be utilized to mitigate other types of transients that might occur in regulated output power (e.g., voltage or current), as described herein.

For purposes of simplicity of explanation, the methodology of FIG. 8 assumes beginning at 300 in a steady state condition. At 310, a desired regulated voltage (or current) is provided. At 320, feedback indicative of electrical characteristics of a load is provided. The feedback, for example, can correspond to providing a reference signal that is functionally related to the regulated output voltage. The reference signal further can be programmed to set the output voltage to one of a selected plurality of output voltages. The regulated voltage can be provided, for example, at a level based on load requirements.

At 330, a determination is made as to whether the reference signal is within expected operating parameters. This determination, for example, can be made by comparing a reference voltage signal relative to a predetermined ramp voltage signal. The expected operating parameters can correspond to being within the normal operating range of the ramp voltage. Thus, if the reference voltage is outside the normal operating range of the ramp voltage (NO), the method can proceed to 340, corresponding to the detection of a transient condition. At 340, the feedback (e.g., a variable resistor) thereof can be trimmed to mitigate a transient condition associated with the output voltage detected at 330. The trimming, for example, can be utilized to help adjust the reference voltage (e.g., by applying a fixed DC offset) to be within the normal operating range of the ramp voltage. From 340, the methodology returns to 320 to continue.

When the feedback is trimmed at 340, power switching devices can be controlled to operate more quickly and, in turn, ramp current up (or down) that is being provided to the load. The early activation of the power switching devices resulting from trimming the feedback helps stabilize the output voltage to the desired regulated voltage. In situations when the feedback is within expected operating parameters (YES), the method returns from 330 to 320 and the regulated voltage can be provided utilizing standard regulation techniques (e.g., pulse width modulation).

What have been described above are examples of the present invention. It is, of course, not possible to describe every conceivable combination of components or methodologies for purposes of describing the present invention, but one of ordinary skill in the art will recognize that many further combinations and permutations of the present invention are possible. For example, the systems and methods described herein can be applied to various types of electrical and electromechanical systems, such as including control of motors (e.g., servo motors, stepper motors, linear motors) by mitigating overshoot and/or undershoot in target voltage or current levels being supplied to drive such motors. Accordingly, the present invention is intended to embrace all such alterations, modifications, and variations that fall within the spirit and scope of the appended claims.

What is claimed is:

1. A power supply system, comprising:
a regulator that supplies regulated electrical energy to an associated load; and
a feedback network that provides a reference signal based on the regulated electrical energy being supplied to the load, the regulator controlling the regulated electrical energy based on the reference signal, the feedback network being modified to adjust the reference signal so as to mitigate a transient condition in the regulated electrical energy.

2. The system of claim 1, wherein the feedback network further comprises a trim component that is dynamically adjusted based on a trim signal indicating an occurrence of the transient condition in the regulated electrical energy.

3. The system of claim 2, wherein the trim component further comprises a resistance that varies based on the trim signal, and the reference signal comprises a voltage reference signal that varies as a function of the resistance of the trim component.

4. The system of claim 1, further comprising a transient detector that provides the trim signal for modifying the feedback network in response to detecting the transient condition in the regulated electrical energy.

5. The system of claim 4, further comprising a comparator that compares the reference signal relative to a predetermined oscillating signal to provide a comparator output signal, the detector being configured to detect the transient condition in the regulated electrical energy based on the comparator output signal indicating that the reference signal is outside an expected range of the oscillating signal for at least a predefined number of clock cycles.

6. The system of claim 1, wherein the feedback network further comprises a resistive network coupled to a node at which the regulated electrical energy is supplied to the load, a portion of the resistive network being trimmed in response to detecting of the transient condition in the regulated electrical so as to facilitate adjusting the reference signal to within a predetermined signal range.

7. The system of claim 1, wherein the regulator further comprises:
a high-side switch;
a low-side switch;
an inductor coupled to a node between the high-side switch and the low-side switch for providing electrical current to the associated load; and
an output capacitor coupled across the associated load,
wherein, in response to detecting the transient condition in the regulated electrical energy, the reference signal is adjusted to enable at least one of the high-side switch and the low-side switch to provide the electrical current relative to the associated load so as to mitigate the transient condition in the regulated electrical energy.

8. The system of claim 7, further comprising:
a comparator that provides a comparator output signal based on comparison of a predetermined oscillating input signal relative to the reference signal; and
a detector that provides a trim signal to cause the feedback network to adjust the reference signal based on the comparator output signal indicating that the reference signal is outside an expected range of the oscillating input signal.

9. The system of claim 8, wherein the feedback network further comprises a trim component that is adjusted based on the trim signal to one of increase and decrease the reference signal so as to reduce a difference between the reference signal and the range of the oscillating input signal, which facilitates operation of at least one of the high-side switch and the low-side switch for mitigating the transient condition in the regulated electrical energy.

10. A portable electronic apparatus comprising the power supply system of claim 1, the apparatus further comprising at least one battery that supplies electrical energy to the power supply system.

11. A power supply system, comprising:
a converter comprising:
a high-side switch;
a low-side switch; and
an inductor coupled to a first node between the high-side switch and the low-side switch and to an output node;
a feedback network that provides a reference signal based on a regulated electrical energy that is supplied to the load; and
a control system that controls the high-side switch and the low-side switch to provide regulated electrical energy at the output node based on the reference signal relative to a predetermined oscillating input signal, the control system dynamically trimming the feedback network to adjust the reference signal based on the reference signal being outside an expected range of the oscillating input signal.

12. The system of claim 11, further comprising a comparator that provides a comparator output signal based on comparison of the oscillating input signal relative to the reference signal, the control system controlling the high-side switch and the low-side switch based on the comparator output signal.

13. The system of claim 11, further comprising a detector that provides a trim signal to trim the feedback network based on the comparator output signal indicating that the reference signal is outside the range of the oscillating input signal for at least a predefined number of clock cycles.

14. The system of claim 13, wherein the feedback network further comprises a trim component having an impedance that is adjusted based on the trim signal to one of increase and decrease the reference signal for mitigating the transient condition in the regulated electrical energy.

15. The system of claim 13, wherein the feedback network further comprises a resistive network coupled to the output node, a portion of the resistive network being variable to a resistance value based on the trim signal so as to facilitate returning the reference signal to within the range of the oscillating input signal.

16. A portable electronic apparatus comprising the power supply system of claim 11, the apparatus further comprising at least one battery that supplies electrical energy to the power supply system.

17. A power supply system, comprising:
means for supplying regulated electrical energy to a load based on a feedback signal indicative of the regulated electrical energy that is supplied to the load; and
means for dynamically trimming the feedback signal to facilitate adjusting the feedback signal to within a range of a predetermined input signal such that the means for supplying the regulated electrical energy is operated to mitigate a transient condition in the regulated electrical energy being supplied to the load.

18. The system of claim 17, further comprising means for detecting the transient condition in the regulated electrical energy based on comparison of the feedback signal relative to the predetermined input signal, the predetermined input signal comprising an oscillating input signal.

19. The system of claim 17, wherein the means for dynamically adjusting the feedback signal further comprises means, which is coupled to a node at which the regulated electrical energy is supplied to the load, for varying resistance in a path of the feedback signal in response to the comparison of the feedback signal relative to the predetermined input signal indicating an occurrence of the transient condition.

20. A method for mitigating transient electrical characteristics in electrical energy supplied to an associated load, the method comprising:
providing regulated electrical energy to the load based on a feedback signal indicative of the regulated electrical energy that is supplied to the load; and
trimming the feedback signal to mitigate a difference between the feedback signal and a range of a predetermined oscillating input signal in response to detecting a potential transient condition in the regulated electrical energy that is being provided to the load.

21. The method of claim 20, further comprising detecting the potential transient condition based on a comparison of the feedback signal with the oscillating input signal, wherein the trimming facilitates returning the feedback signal to within the range of the oscillating input signal.

22. The method of claim 21, wherein the providing regulated electrical energy further comprises controlling a switch network to supply electrical current to the load based on the comparison indicating that the feedback signal is within the range of the oscillating input signal.
